(19) United States
(12) Patent Application Publication
(10) Pub. No.: US 2021/0032519 A1
(43) Pub. Date: Feb. 4, 2021

(54) CATALYTIC COMPOSITION FOR AN ADHESIVE COMPOSITION BASED ON A CROSS-LINKABLE SILYLATED POLYMER

(71) Applicant: BOSTIK SA, Colombes (FR)

(72) Inventors: Olivier LAFERTE, Venette (FR); Bruno DELMOTTE, Venette (FR); Boris COLIN, Venette (FR)

(73) Assignee: BOSTIK SA, Colombes (FR)

(21) Appl. No.: 17/040,001

(22) PCT Filed: Mar. 14, 2019
(86) PCT No.: PCT/FR2019/050571

§ 371 Date: Sep. 21, 2020

(30) Foreign Application Priority Data
Mar. 21, 2018 (FR) 1852398

(51) Int. Cl. C09J 201/10; B01J 31/22; B01J 31/02

(52) U.S. Cl. CPC C09J 201/10; B01J 31/22; B01J 2531/46; B01J 31/0265; B01J 31/0237

(57) ABSTRACT

1) Adhesive composition comprising at least one crosslinkable silylated polymer (A) and a catalytic composition (B) comprising:
a tertiary amine (C) with a pKa of greater than 11 and
an organometallic compound (D) obtained by reacting a metal alkoxide (D1) with an oxime (D2).

2) Corresponding catalytic composition (B).

The present invention relates to an adhesive composition comprising at least one crosslinkable silylated polymer and a catalytic composition. The invention also relates to said catalytic composition, and also to a bonding process comprising the application of said adhesive composition.

Silylated polymers may be used in various types of applications, for example in adhesive compositions that may be used for all types of bonding such as the bonding of surface coatings, or which may be used for forming a sealing membrane or for preparing self-adhesive articles.

Silylated polymers may be crosslinked even at room temperature by reaction of the reactive silyl group with atmospheric moisture. In order to accelerate the crosslinking of the silylated polymer, it is possible to add to the silylated polymer a crosslinking catalyst.

Generally, the crosslinking catalyst used in adhesive compositions based on silylated polymers is a tin-based catalyst such as dibutyltin dilaurate (DBTDL), dibutyltin diacetate, dibutyltin bis(acetylacetonate) or dioctyltin.

However, the toxicity of these tin-based catalysts is increasingly being highlighted, which leads manufacturers to avoid their use.

Tin-free catalysts have been developed for the crosslinking of silylated polymers, among which mention may be made of bismuth neodecanoate or zinc octoate or neodecanoate. These tin-free catalysts are 2 to 3 times less efficient than tin-based catalysts. Thus, to obtain crosslinking times equivalent to those obtained with tin-based catalysts, it will be necessary to introduce 2 to 3 times more catalyst of bismuth neodecanoate or zinc octoate type.

The crosslinking catalyst must make it possible to accelerate the crosslinking of the silylated polymer during its use. It must also remain stable during storage of the adhesive composition before use; in other words, it must conserve its ability to accelerate the crosslinking of said polymer, after storage of the adhesive composition up to the time of its use by the end user.

In addition, for optimum use of the adhesive composition, said adhesive composition must not crosslink during its storage.

Patent application WO 2017/216446 describes an adhesive composition comprising a silylated polymer and, as catalyst, a metal compound obtained by reaction of a metal alkoxide with an oxime. However, the rate of crosslinking of said adhesive composition still remains to be improved.

One aim of the present invention is to propose a novel crosslinkable adhesive composition free of tin, in particular of alkyl tin, which has an improved crosslinking time, while at the same time having good stability, in particular on storage.

Another aim of the present invention is to propose a tin-free catalytic composition whose efficiency for crosslinking a silylated polymer is improved.

Another aim of the present invention is to propose a catalytic composition free of tin, in particular of alkyl tin, which imparts improved mechanical properties to the adhesive seal formed by the crosslinking of said crosslinkable adhesive composition.

A subject of the present invention is, firstly, an adhesive composition comprising:
at least one silylated polymer (A) comprising at least one, preferably at least two, groups of formula (I):

—Si(R⁴)ₚ(OR⁵)₃₋ₚ (I)
in which:
   R⁴ represents a linear or branched alkyl radical comprising from 1 to 4 carbon atoms, with the possibility that when there are several radicals R⁴, these radicals are identical or different;
   R⁵ represents a linear or branched alkyl radical comprising from 1 to 4 carbon atoms, with the possibility that when there are several radicals R⁵, these radicals are identical or different, with the possibility that two groups OR⁵ may be engaged in the same ring;
   p is an integer equal to 0, 1 or 2, preferably equal to 0 or 1; and
a catalytic composition (B) comprising:
   a tertiary amine (C) with a pKa of greater than 11; and
   an organometallic compound (D) obtained by reacting at least one metal alkoxide (D1) with at least one oxime (D2) chosen from an oxime of formula (V) or an oxime of formula (VI):

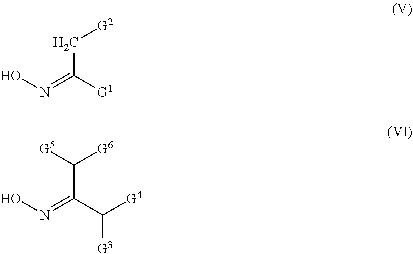

in which:
G¹ is a hydrogen atom or a linear or branched alkyl radical comprising from 1 to 4 carbon atoms;
G² is a hydrogen atom or a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical or a radical —N(G⁷G⁸) in which G⁷ and G⁸ represent, independently of each other, a linear or branched alkyl radical comprising from 1 to 10 carbon atoms or a linear or branched alkenyl radical comprising from 2 to 10 carbon atoms or a benzyl radical;
G³ represents either a hydrogen atom, or an alkyl group containing from 1 to 4 carbon atoms, or forms the residue of an aliphatic ring containing between 4 and 14 carbon atoms with the groups G⁴ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
G⁴ represents either a hydrogen atom, or an alkyl group containing from 1 to 4 carbon atoms, or forms the residue of an aliphatic ring containing between 4 and 14 carbon atoms with the groups G³ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G³ or G⁴ forms the residue of an aliphatic ring with at least one of the groups G⁵ or G⁶.
G⁵ represents either a hydrogen atom, or an alkyl group containing from 1 to 4 carbon atoms, or forms the residue of an aliphatic ring containing between 4 and 14 carbon atoms with the groups G³ and/or G⁴ and/or G⁶, said aliphatic ring optionally comprising one or more heteroatoms and/or one or more double bonds and said aliphatic ring being optionally substituted with one or more alkyl groups containing from 1 to 4 carbon atoms;
G⁶ represents either a hydrogen atom, or an alkyl group containing from 1 to 4 carbon atoms, or forms the residue of an aliphatic ring containing between 4 and 14 carbon atoms with the groups G³ and/or G⁴ and/or G⁵, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G⁵ or G⁶ forms the residue of an aliphatic ring with at least one of the groups G³ or G⁴.

It has been found that the presence, in the catalytic composition (B), of the tertiary amine (C) makes it possible, surprisingly, to significantly lower the crosslinking time of the adhesive composition, relative to patent application WO 2017/216446, the stability of (B) otherwise remaining entirely satisfactory.

For the purposes of the present invention, the term “adhesive composition” also denotes mastic compositions or surface coating compositions.

The composition according to the invention is crosslinkable in the presence of humidity or after humidifying.

### Silylated Polymer (A)

For the purposes of the present invention, the term “silylated polymer” means a polymer including at least one alkoxysilane group. Preferably, the silylated polymer including at least one alkoxysilane group is a polymer comprising at least one, preferably at least two, groups of formula (I):

—Si(R⁴)ₚ(OR⁵)₃₋ₚ (I)

in which:
R⁴ represents a linear or branched alkyl radical comprising from 1 to 4 carbon atoms, with the possibility that when there are several radicals R⁴, these radicals are identical or different;
R⁵ represents a linear or branched alkyl radical comprising from 1 to 4 carbon atoms, with the possibility that when there are several radicals R⁵, these radicals are identical or different, with the possibility that two groups OR⁵ may be engaged in the same ring;
p is an integer equal to 0, 1 or 2, preferably equal to 0 or 1.

The silylated polymer as defined above comprises at least one crosslinkable alkoxysilane group. The crosslinkable alkoxysilane group is preferably in the terminal position of said polymer. A position in the middle of the chain is, however, not excluded. The silylated polymer is not crosslinked before the application of the adhesive composition. The adhesive composition is applied under conditions that enable the crosslinking thereof.

The silylated polymer (A) is generally in the form of a more or less viscous liquid. Preferably, the silylated polymer has a viscosity ranging from 10 to 200 Pa·s, preferably ranging from 20 to 175 Pa·s, said viscosity being measured, for example, according to a Brookfield-type method at 23° C. and 50% relative humidity (S28 needle).

The silylated polymer (A) preferably comprises two groups of formula (I), but it may also comprise from three to six groups of formula (I).

Preferably, the silylated polymer(s) (A) have an average molar mass ranging from 500 to 50 000 g/mol, more preferably ranging from 700 to 20 000 g/mol. The molar mass of the polymers may be measured by methods well known to a person skilled in the art, for example by NMR and size exclusion chromatography using polystyrene standards.

According to one embodiment of the invention, the silylated polymer (A) corresponds to one of the formulae (II), (III) or (IV):

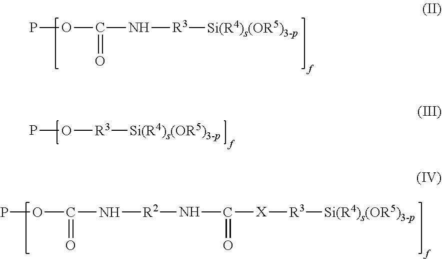

in which:
R⁴, R⁵ and p have the same meaning as in formula (I) described above,
P represents a saturated or unsaturated, linear or branched polymeric radical optionally comprising one or more heteroatoms, such as oxygen, nitrogen, sulfur or silicon, and preferably having a number-average molar mass ranging from 100 g/mol to 48 600 g/mol, more particularly from 300 g/mol to 18 600 g/mol or from 500 g/mol to 12 600 g/mol,
R¹ represents a divalent hydrocarbon-based radical comprising from 5 to 15 carbon atoms, which may be aromatic or aliphatic, linear, branched or cyclic,
R³ represents a linear or branched divalent alkylene radical comprising from 1 to 6 carbon atoms, preferably from 1 to 3 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6, preferably ranging from 2 to 5, preferably from 2 to 4, more preferably from 2 to 3.

Preferably, in formulae (II), (III) and/or (IV) above, P represents a polymer radical chosen, in a nonlimiting manner, from polyethers, polycarbonates, polyesters, polyolefins, polyacrylates, polyether polyurethanes, polyester polyurethanes, polyolefin polyurethanes, polyacrylate polyurethanes, polycarbonate polyurethanes, and block polyether/polyester polyurethanes.

For example, EP 2468783 describes silylated polymers of formula (II) in which P represents a polymeric radical containing polyurethane/polyester/polyether blocks.

According to one embodiment, the silylated polymers are chosen from silylated polyurethanes, silylated polyethers, and mixtures thereof.

According to a particular embodiment, the silylated polymer corresponds to one of the formulae (II′), (III′) or (IV′):

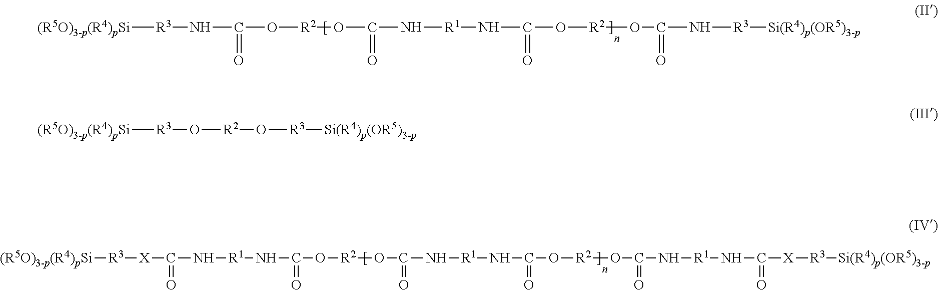

in which formulae (II′), (III′) and (IV′):
R¹, R³, R⁴, R⁵, X, R⁷ and p have the same meaning as in formulae (II), (III) and (IV) described above,
R² represents a saturated or unsaturated, linear or branched divalent hydrocarbon-based radical optionally comprising one or more heteroatoms, such as oxygen, nitrogen, sulfur or silicon, and preferably having a number-average molar mass ranging from 100 g/mol to 48 600 g/mol, more particularly from 300 g/mol to 18 600 g/mol or from 500 g/mol to 12 600 g/mol,
n is an integer greater than or equal to 0.

In the silylated polymers of formulae (II′), (III′) or (IV′) defined above, when the radical R² comprises one or more heteroatoms, said heteroatom(s) are not present at the end of the chain. In other words, the free valencies of the divalent radical R² bonded to the oxygen atoms neighboring the silylated polymer each originate from a carbon atom. Thus, the main chain of the radical R² is terminated with a carbon atom at each of the two ends, said carbon atom then having a free valency.

According to one embodiment, the silylated polymers (A) are obtained from polyols chosen from polyether polyols, polyester polyols, polycarbonate polyols, polyacrylate polyols, polysiloxane polyols and polyolefin polyols, and mixtures thereof, and more preferably from diols chosen from polyether diols, polyester diols, polycarbonate diols, polyacrylate diols, polysiloxane diols, polyolefin diols, and mixtures thereof. In the case of the polymers of formula (II′), (III′) or (IV′) described above, such diols may be represented by the formula HO—R²—OH where R² has the same meaning as in formula (II′), (III′) or (IV′).

For example, among the radicals of the type R² which may be present in formula (II′), (III′) or (IV′), mention may be made of the following divalent radicals, of which the formulae below show the two free valencies:
derivative of a polypropylene glycol:

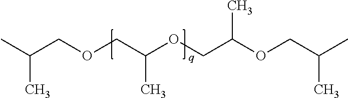

derivative of a polyester diol:

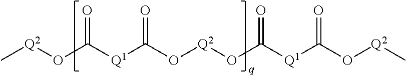

derivative of a polybutadiene diol:

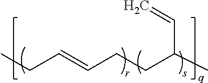

derivative of a polyacrylate diol:

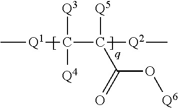

derivative of a polysiloxane diol:

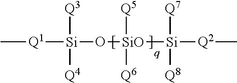

in which:

q represents an integer such that the number-average molecular mass of the radical R² ranges from 100 g/mol to 48 600 g/mol, preferably from 300 g/mol to 18 600 g/mol, more preferably from 500 g/mol to 12 600 g/mol,

r and s represent zero or a non-zero integer such that the number-average molecular mass of the radical R² ranges from 100 g/mol to 48 600 g/mol, preferably from 300 g/mol to 18 600 g/mol, more preferably from 500 g/mol to 12 600 g/mol, it being understood that the sum r+s is other than zero,

Q¹ represents a linear or branched, saturated or unsaturated aromatic or aliphatic divalent alkylene radical preferably containing from 1 to 18 carbon atoms, more preferably from 1 to 8 carbon atoms,

Q² represents a linear or branched divalent alkylene radical preferably containing from 2 to 36 carbon atoms, more preferably from 1 to 8 carbon atoms,

Q³, Q⁴, Q⁵, Q⁶, Q⁷ and Q, represent, independently of each other, a hydrogen atom or an alkyl, alkenyl or aromatic radical preferably containing from 1 to 12 carbon atoms, preferably from 2 to 12 carbon atoms, more preferably from 2 to 8 carbon atoms.

According to one embodiment, R¹ is chosen from one of the following divalent radicals, of which the formulae below show the two free valencies:

a) the divalent radical derived from isophorone diisocyanate (IPDI):

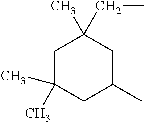

b) the divalent radical derived from dicyclohexylmethane diisocyanate (H12MDI)

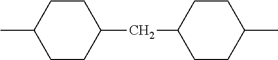

c) the divalent radical derived from toluene diisocyanate (TDI)

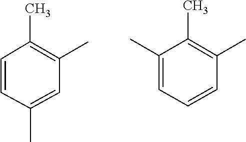

d) the divalent radicals derived from the 4,4′ and 2,4′ isomers of diphenylmethane diisocyanate (MDI)

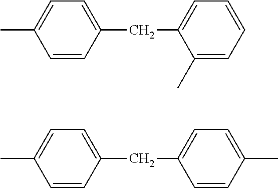

e) the divalent radical derived from hexamethylene diisocyanate (HDI) —(CH₂)₆—
f) the divalent radical derived from m-xylylene diisocyanate (m-XDI).

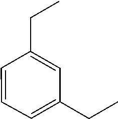

The polymers of formula (II) or (II′) may be obtained according to a process described in EP 2336208 and WO 2009/106699. A person skilled in the art will know how to adapt the manufacturing process described in these two documents in the case of the use of different types of polyols. Among the polymers corresponding to formula (II), mention may be made of:
Geniosil® STP-E10 (available from Wacker): polyether comprising two groups (I) of dimethoxy type (n equal to 0, p equal to 1 and R⁴ and R⁵ represent a methyl group) having a number-average molar mass of 8889 g/mol where R³ represents a methyl group;
Geniosil® STP-E30 (available from Wacker): polyether comprising two groups (I) of dimethoxy type (n equal to 0, p equal to 1 and R⁴ and R⁵ represent a methyl group) having a number-average molar mass of 14 493 g/mol where R³ represents a methyl group;
Spur+® 1050 MM (available from Momentive): polyurethane comprising two groups (I) of trimethoxy type (n other than 0, p equal to 0 and R⁵ represents a methyl group) having a number-average molar mass of 16 393 g/mol where R³ represents an n-propyl group;
Spur+® Y-19116 (available from Momentive): polyurethane comprising two groups (I) of trimethoxy type (n other than 0 and R⁵ represents a methyl group) having a number-average molar mass ranging from 15 000 to 17 000 g/mol g/mol where R³ represents an n-propyl group;
Desmoseal® S XP 2636 (available from Bayer): polyurethane comprising two groups (I) of trimethoxy type (n other than 0, p equal to 0 and R⁵ represents a methyl group) having a number-average molar mass of 15 038 g/mol where R³ represents an n-propylene group.

The polymers of formula (III) or (III′) may be obtained by hydrosilylation of polyether diallyl ether according to a process described, for example, in EP 1 829 928. Among the polymers corresponding to formula (III), mention may be made of:
the polymer MS SAX@ 350 (available from Kaneka) corresponding to a polyether comprising two groups (I) of dimethoxy type (p equal to 1 and R⁴ and R⁵ represent a methyl group) having a number-average molar mass ranging from 14 000 to 16 000 g/mol;
the polymer MS SAX@ 260 (available from Kaneka) corresponding to a polyether comprising two groups (I) of dimethoxy type (p equal to 1, R⁴ and R⁵ represent a methyl group) having a number-average molar mass of 16 000 to 18 000 g/mol where R³ represents an ethyl group;
the polymer MS S303H (available from Kaneka) corresponding to a polyether comprising two groups (I) of dimethoxy type (p is equal to 1 and R⁴ represents a methyl group) having a number-average molecular mass of about 22 000 daltons.

The polymers of formula (IV) or (IV′) may be obtained, for example, by reaction of polyol(s) with one or more diisocyanates followed by a reaction with aminosilanes or mercaptosilanes. A process for preparing polymers of formula (IV) or (IV′) is described in EP 2 583 988. A person skilled in the art will know how to adapt the manufacturing process described in said document in the case of using different types of polyols.

According to a preferred embodiment of the invention, the adhesive composition comprises at least one silylated polymer of formula (II) and/or (II′) or at least one silylated polymer of formula (III) and/or (III′).

According to a most particularly preferred embodiment of the invention, the adhesive composition comprises at least one silylated polymer of formula (III′), notably in which R² is a divalent radical derived from a polyether, preferably from a poly(oxyalkylene) diol and even more particularly from a polypropylene glycol. The crosslinking time of said adhesive composition is then lowered entirely advantageously.

The silylated polymer(s) (A) may represent at least 5% by weight, preferably at least 10% by weight, more preferably at least 15% by weight, relative to the total weight of the adhesive composition. Generally, the content of silylated polymer(s) in the adhesive composition is preferably less than or equal to 90% by weight, more preferably less than or equal to 80% by weight, even more preferentially less than or equal to 70% by weight, advantageously less than or equal to 60% by weight, relative to the total weight of the adhesive composition.

The amount of silylated polymers (A) in the adhesive composition may depend on the use of said adhesive composition. Specifically, for a mastic composition, the adhesive composition will preferably comprise from 5% to 50% by weight of silylated polymers, preferably from 10% to 40% by weight of silylated polymers, relative to the total weight of the adhesive composition. For an adhesive composition used for the formulation of pressure-sensitive self-adhesive articles (of PSA type), the adhesive composition will preferably comprise from 10% to 99.9% by weight, preferably from 15% to 90% by weight, more preferably from 20% to 80% by weight, of silylated polymers relative to the total weight of the adhesive composition.

### Catalytic Composition (B)

The catalytic composition (B) is intended for crosslinking the silylated polymer (A) which is included in the adhesive composition. The catalytic composition (B), as defined in the present invention, is stable, in particular on storage of the adhesive composition.

On storage of the adhesive composition, the polymer (A) is in crosslinkable (non-crosslinked) form. The crosslinking of the silylated polymer (A) takes place during the application of the adhesive composition to a surface, in the presence of atmospheric moisture, to ensure bonding or to form a coating or sealing. The stability of the catalytic composition (B) advantageously corresponds to maintenance of the crosslinking time of the adhesive composition, after storage thereof.

The catalytic composition (B) comprises:
a tertiary amine (C) with a pKa of greater than 11; and
an organometallic compound (D) obtained by reacting at least one metal alkoxide (D1) with at least one oxime (D2) chosen from an oxime of formula (V) or (VI) as defined previously.

The tertiary amine (C) is advantageously a strong base whose pKa is greater than 11.

According to one embodiment, the catalytic composition (B) comprises, as tertiary amine (C), a phosphazene (C1) of formula (VII):

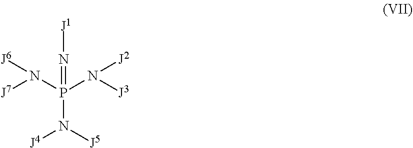

in which:
J¹ represents a linear or branched alkyl radical comprising from 1 to 6 carbon atoms,
J² and J³ represent, independently of each other, an alkyl radical comprising from 1 to 4 carbon atoms or together form, with the nitrogen atom to which they are attached, an aliphatic heterocycle comprising from 4 to 6 carbon atoms;
J⁴ and J⁵ represent, independently of each other, an alkyl radical comprising from 1 to 4 carbon atoms or together form, with the nitrogen atom to which they are attached, an aliphatic heterocycle comprising from 3 to 4 carbon atoms;
J⁶ and J⁷ represent, independently of each other, an alkyl radical comprising from 1 to 4 carbon atoms or together form, with the nitrogen atom to which they are attached, an aliphatic heterocycle comprising from 4 to 6 carbon atoms;
   it also being understood that J⁴ (or J⁵) may form with at least one of the groups J⁶ (or J⁷) and/or J² (or J³), and also with the two nitrogen atoms and the phosphorus atom to which they are attached, an aliphatic ring comprising 3 to 4 carbon atoms.

The phosphazenes (C1) of formula (VII) are prepared according to methods known to those skilled in the art, and some are also commercially available. The following may thus be mentioned:
the catalyst having the formula below:

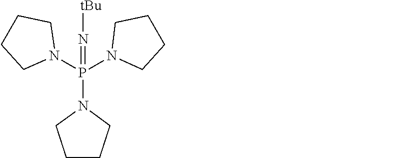 [SMILES: CC(C)(C)N=P(N1CCCC1)(N1CCCC1)N1CCCC1]

which is available from Sigma-Aldrich under the name phosphazene base P1-tert-butyl-tris(tetramethylene) (also known as P1).
the catalyst having the formula below:

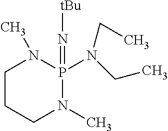 [SMILES: CCN(CC)P1(=NC(C)(C)C)N(C)CCCN1C]

which is available from Sigma-Aldrich under the name 2-tert-Butylimino-2-diethylamino-1,3-dimethylperhydro-1,3,2-diazaphosphorine (also known as BEMP).

According to another embodiment, the catalytic composition (B) comprises, as tertiary amine (C), a guanidine or an amidine with a pKa of greater than 11, which is preferentially chosen from the following compounds:
1,8-diazabicyclo[5.4.0]undec-7-ene (or DBU), with a pKa equal to 12.5 and having the formula:

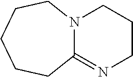 [SMILES: C1CCC2=NCCCN2CC1]

1,5,7-triazabicyclo[4.4.0]dec-5-ene (or TBD), with a pKa equal to 13.7 and having the formula:

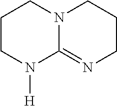

1,5-diazabicyclo[4.3.0]non-5-ene (or DBN), with a pKa equal to about 12 and having the formula:

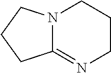

These compounds are also commercially available, for example from the company Safic Alcan for DBU, and from the company Sigma-Aldrich for TBD and for DBN.

The catalytic composition (B) comprises an organometallic compound (D) which is obtained by reacting a metal alkoxide (D1) with an oxime (D2) of formula (V) or (VI).

The metal alkoxide (D1) may be, for example, in the form of formula (VIII):

M(OR)_{y} (VIII)

in which:
M represents a metal atom, preferably chosen from titanium, zirconium, aluminum, zinc, bismuth, silicon, hafnium, barium, cerium, cesium, rubidium and antimony,
y is equal to 1, 2, 3 or 4 according to the valency of the metal atom M, and
R represents an alkyl, alkenyl, carbonyl-alkyl or carbonyl-alkenyl group, said alkyl or alkenyl radical comprising from 1 to 22 carbon atoms, preferably from 1 to 15 carbon atoms.

Thus, for the purposes of the present invention, a metal alkoxide also covers the metal alkanoates for which the radical R above is a carbonyl-alkyl or carbonyl-alkenyl.

It appears that the reaction between the metal alkoxide (D1) and the oxime (D2) may be represented by the following schematic equation:

M(OR)_{y}+x R′R″C═NOH→M(OR)_{y-x}(ON═CR′R″)ₓ+x ROH

in which:
M(OR)_{y} corresponds to formula (VIII) as defined previously,
R′R″C═NOH represents the oxime,
x is an integer chosen from 1, 2, 3 and 4, ranging from 1 to the valency of the corresponding metal M.

Without wishing to be bound by any theory, the inventors have thus discovered that the combination of the tertiary amine (C) with an organometallic compound comprising at least one bond of the type “M-O—N” where M represents a metal atom, O represents an oxygen atom and N represents a nitrogen atom, has more improved catalytic properties, relative to said organometallic compound alone, in a composition comprising crosslinkable silylated polymers. These improved catalytic properties notably have the effect of further lowering the crosslinking time relative to patent application WO 2017/216446.

Preferably, the metal alkoxide is in the form of formula (VIII) in which:
M represents a metal atom chosen from titanium, bismuth, zinc, rubidium and cesium; and
R represents a linear or branched alkyl or alkenyl group, preferably alkyl, containing from 1 to 5 carbon atoms, preferably from 2 to 4 carbon atoms, preferably from 3 to 4 carbon atoms; or
R represents a carbonyl-alkyl group, the alkyl radical of which comprises from 1 to 14 carbon atoms.

According to an advantageous embodiment of the invention, the metal alkoxide is chosen from titanium alkoxides or bismuth, zinc, rubidium or cesium alkanoates.

A titanium alkoxide is more particularly preferred, and most particularly the compound: Ti(OnBu)₄. in which “nBu” represents the n-butyl group (—CH₂—CH₂—CH₂—CH₃).

Among the bismuth, zinc, rubidium or cesium alkanoates, the following compounds are particularly preferred: Bi[O(C═O)C₉H₁₉]₂; Zn[O(C═O)C₉H₁₉]₂; Rb[O(C═O)C₉H₁₉]; Cs[O(C═O)C₉H₁₉].

The metal alkoxides of formula (VIII) are commercially available products. Thus:
Ti(OnBu)₄ is available from Sigma-Aldrich or Dorf Ketal under the trade name Tyzor® TnBT;
Zn[O(C═O)C₉H₁₉]₂ is available from the company Borchers under the trade name Borchi® KAT 15;
Bi[O(C═O)C₉H₁₉]₂ is available from the company Borchers under the trade name Borchi® KAT 315;
Rb[O(C═O)C₉H₁₉] is available from the company TIB Chemicals under the trade name TIB KAT® VP16-626;
Cs[O(C═O)C₉H₁₉] is available from the company TIB Chemicals under the trade name TIB KAT® VP15-796.

The catalytic composition (B) comprises an organometallic compound (D) which is obtained by reacting the metal alkoxide (D1) with an oxime (D2) of formula (V) or (VI).

According to one embodiment of the invention, in formula (V) of the oxime (D2), G¹ preferably represents a methyl group or an ethyl group, more preferably a methyl group.

According to one embodiment of the invention, in formula (V), G² preferably represents hydrogen or a linear or branched alkyl group comprising from 1 to 8 carbon atoms, preferably from 1 to 6 carbon atoms, more preferably from 1 to 4 carbon atoms, or a phenyl group, or a group —N(G⁷G⁸) where G⁷ and G⁸ preferably represent a methyl, ethyl, propyl, butyl, pentyl or benzyl (—CH₂—C₆H5) group, more preferably a methyl, ethyl, propyl or benzyl group.

The oxime of formula (VI) may be monocyclic or polycyclic, preferably monocyclic.

For example, in the case of a polycyclic oxime of formula (VI), when G³ forms a ring with G⁵ or G⁶ and when G⁴ forms a ring with G⁵ or G⁶ and when G³ and G⁴ (and G⁵ and G⁶) are engaged in the same ring, then the oxime has a tricyclic structure, for example of adamantane or norbornene type.

According to one embodiment of the invention, in formula (VI),
G³ and G⁶ each represent a hydrogen atom, and/or
G⁴ and G⁵ form an aliphatic ring, which is preferably saturated, containing from 4 to 14 carbon atoms, preferably from 5 to 12 carbon atoms, more preferably 6 carbon atoms, said ring being optionally substituted with one or more methyl, ethyl and/or propyl groups and said ring optionally comprising one or more heteroatoms chosen from an oxygen atom, a sulfur atom and a nitrogen atom, said nitrogen atom then not being bonded to a hydrogen atom.

As examples of oximes of formula (VI), mention may be made of cyclohexanone oxime and cyclododecanone oxime. These two compounds are widely commercially available. Thus, cyclohexanone oxime may be obtained from the company OMG Borchers under the trade name Borchi® NOX C3.

According to a particular embodiment of the invention, the organometallic compound (D) is obtained by reacting:
an alkoxide (D1) chosen from the following compounds: Ti(OnBu)₄, Zn[O(C═O)C₉H₁₉], Bi[O(C═O)C₉H₁₉]₂;
and an oxime (D2) chosen from the oximes of formula (VI-1):

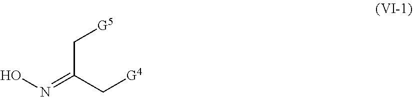

in which:
G⁴ and G⁵ form a saturated aliphatic ring containing from 5 to 11 carbon atoms.

According to a particular embodiment of the invention, the organometallic compound (D) is chosen from the following compounds:
product of reaction between an alkoxide of formula Ti(OnBu)₄ and cyclohexanone oxime;
product of reaction between an alkoxide of formula Zn[O(C═O)C₉H₁₉]₂ and cyclohexanone oxime;
product of reaction between an alkoxide of formula Bi[O(C═O)C₉H₁₉]₂ and cyclohexanone oxime;
product of reaction between an alkoxide of formula Rb[O(C═O)C₉H₁₉] and cyclohexanone oxime;
product of reaction between an alkoxide of formula Cs[O(C═O)C₉H₁₉] and cyclohexanone oxime.

According to one embodiment of the invention, the organometallic compound (D) is obtained by reacting the metal alkoxide (D1) with the oxime (D2) in an alkoxide/oxime mole ratio ranging from 1:1 to 1:6, preferably ranging from 1:1 to 1:4. This embodiment is particularly preferred in the case where the metal of the metal alkoxide is tetravalent. In the case where the metal of the metal alkoxide is trivalent, the alkoxide/oxime mole ratio preferably ranges from 1:1 to 1:3. This same mole ratio preferably ranges from 1:1 to 1:2, in the case of a divalent metal, and will be about 1:1 in the case of a monovalent metal.

The catalytic composition (B) comprises the tertiary amine (C) and the organometallic compound (D) in a respective amount corresponding to a ratio: number of moles of (C)/number of moles of the metal alkoxide (D1) within the range from 0.5 to 25, preferably from 1 to 5.

According to one embodiment, the catalytic composition (B) consists essentially of the tertiary amine (C) and of the organometallic compound (D).

According to another embodiment, the catalytic composition (B) comprises, besides the tertiary amine (C) and the organometallic compound (D), an organosilicon compound (E) chosen from:
a silsesquioxane (E1);
a compound (E2) of formula (IX):

K[—Si(OR⁶)₃]ᵥ (IX)
in which:
   K is a saturated or unsaturated, linear or branched hydrocarbon-based radical comprising from 2 to 15 carbon atoms and one or more heteroatoms chosen from nitrogen and oxygen;
   R⁶ represents a linear or branched alkyl or alkenyl group, preferably alkyl, containing from 1 to 5 carbon atoms, preferably from 1 to 2 carbon atoms;
   v equal to 1, 2 or 3; and
a tetraethyl orthosilicate oligomer (E3).

This embodiment is particularly advantageous since it makes it possible to obtain improved mechanical properties for the adhesive seal which is formed by the crosslinking of the adhesive composition.

According to an even more preferred variant of this embodiment, the tertiary amine (C) is chosen from an amidine and a guanidine, and the organometallic compound (D) is obtained from a titanium alkoxide, preferably from Ti(OnBu)₄. The adhesive seal formed by the crosslinking of the adhesive composition is advantageously cohesive.

Silsesquioxanes are typically organosilicon compounds which can adopt a polyhedral structure or a polymeric structure, with Si—O—Si bonds. They typically have the following general structure:

[RSiO_{3/2}]t

in which R, which may be identical or different in nature, represents an organic radical and t is an integer which may range from 6 to 12, t preferably being equal to 6, 8, 10 or 12.

According to one embodiment, the silsesquioxane (A) has a polyhedral structure (or POSS for “Polyhedral Oligomeric Silsesquioxane”).

Preferably, the silsesquioxane (A) corresponds to the general formula (X) below:

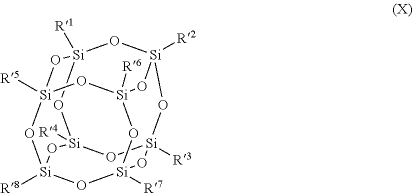

in which each of R′¹ to R′⁸ represents, independently of each other, a group chosen from:
a hydrogen atom,
a radical chosen from the group consisting of a linear or branched C1-C4 alkoxy radical, a linear or branched alkyl radical comprising from 1 to 30 carbon atoms, an alkenyl radical comprising from 2 to 30 carbon atoms, an aromatic radical comprising from 6 to 30 carbon atoms, an allyl radical comprising from 3 to 30 carbon atoms, a cyclic aliphatic radical comprising from 3 to 30 carbon atoms and an acyl radical comprising from 1 to 30 carbon atoms, and
a group —OSiR′⁹R′¹⁰ in which R′⁹ and R′¹⁰ each represents, independently of each other, a hydrogen atom or a radical chosen from the group consisting of linear or branched C1-C4 alkyls, linear or branched C1-C4 alkoxys, C2-C4 alkenyls, a phenyl, a C3-C6 allyl radical, a cyclic C3-C8 aliphatic radical and a C1-C4 acyl radical;

provided:
that at least one radical among the radicals R′¹ to R′⁸ is a C1-C4 alkoxy radical; and
that at least one radical among the radicals R′¹ to R′⁸ is a phenyl radical.

Silsesquioxanes are known compounds that are notably described in patent application WO 2008/107331. Some are also commercially available, thus the product from Dow sold under the name: Dow Corning® 3074 and Dow Corning® 3037 (CAS number=68957-04-0).

Compound (E2) of formula (IX) is advantageously chosen from:
Tris-[3-(trimethoxysilyl)propyl] isocyanurate (CAS number=26115-70-8), of formula:

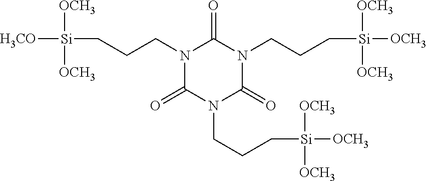 [SMILES: CO[Si](CCCn1c(=O)n(CCC[Si](OC)(OC)OC)c(=O)n(CCC[Si](OC)(OC)OC)c1=O)(OC)OC]

which is sold by Wacker under the name Geniosil® GF 69;
-Bis(trimethoxysilylpropyl)amine) (CAS number=82985-35-1), of formula:

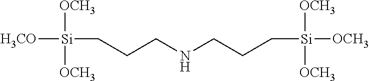 [SMILES: CO[Si](CCCNCCC[Si](OC)(OC)OC)(OC)OC]

which is sold by Evonik under the name Dynasylan® 1124; and
Tris(triethoxysilylpropyl)amine (CAS number=18784-74-2), of formula:

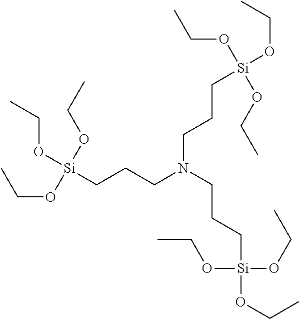 [SMILES: CCO[Si](CCCN(CCC[Si](OCC)(OCC)OCC)CCC[Si](OCC)(OCC)OCC)(OCC)OCC]

which is sold by Gelest under the code SIT8716.3.

The tetraethyl orthosilicate oligomer (E3) is also known as TEOS oligomer and corresponds to the formula:

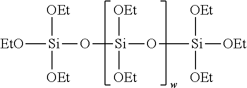

in which w is an integer between 1 and 10.

Such an oligomer is sold by Wacker under the name Wacker TES 40 WN.

When the catalytic composition (B) comprises, besides the tertiary amine (C) and the organometallic compound (D), the organosilicon compound (E), the latter is advantageously present in an amount corresponding to a ratio: number of moles of (E)/number of moles of the metal alkoxide (D1) within the range from 0.1 to 5, preferably from 0.3 to 1.

According to a preferred variant, the catalytic composition (B) also comprises a solvent (S). This variant is notably preferred when the oxime (D2) is a compound that is solid at room temperature.

For the purposes of the present invention, the term “solvent” means a compound or a composition which is liquid at room temperature and which is capable of dissolving solid or liquid substances via a mechanism of physical nature, without chemically reacting with said substances. Thus, the term “solvent” also includes a substance which is usually denoted by the term “plasticizer”, on condition that said substance is capable of dissolving the ingredients present in the catalytic composition (B) without chemically reacting therewith.

Among the possible solvents, mention may be made of a polar solvent such as tetrahydrofuran (THF), ethyl acetate, methyl ethyl ketone or xylene.

Among the plasticizers, mention may be made of:
pentaerythrityl tetravalerate, which is sold under the brand name Pevalen™ by the company Perstorp;
a phenyl (C10-C18) alkylsulfonate (CAS number=70775-94-9) such as the product sold under the name Mesamoll® by the company Lanxess;
diisononyl 1,2-cyclohexanedicarboxylate, which is sold under the name Hexamoll Dinch® by the company BASF;
esters of benzoic acid, of phthalic acid, of trimellitic acid, of pyromellitic acid, of adipic acid, of sebacic acid, of fumaric acid, of maleic acid, of itaconic acid or of citric acid;
polyester, polyether or hydrocarbon mineral oil derivatives.

Among the derivatives of phthalic acid, mention may notably be made of phthalates, such as dibutyl phthalate, dioctyl phthalate, dicyclohexyl phthalate, diisooctyl phthalate, diisodecyl phthalate, dibenzyl phthalate or butylbenzyl phthalate.

The amount of solvent to be introduced into the catalytic composition (B) is readily determined by a person skilled in the art, so as to dissolve the alkoxide (D1) and the oxime (D2), this amount also generally being sufficient to dissolve the tertiary amine (C) and the organosilicon compound (E), when the latter is present. In general, an amount of solvent corresponding to a ratio: number of moles of (S)/number of moles of the metal alkoxide (D1) within the range extending up to 6 is suitable.

According to one embodiment, the catalytic composition (B) consists essentially of the tertiary amine (C), the organometallic compound (D) and the solvent (S).

According to another embodiment, the catalytic composition (B) consists essentially of the tertiary amine (C), the organometallic compound (D), the organosilicon compound (E) and the solvent (S).

The catalytic composition (B) may represent at least 0.05% by weight, preferably from 0.1% to 10% by weight, preferably from 0.5% to 5% by weight and even more preferentially from 0.5% to 2% of the total weight of the adhesive composition.

The catalytic composition (B) is prepared by means of a process which comprises the steps:

(i) of mixing the metal alkoxide (D1) with the oxime (D2) to form the organometallic compound (D), preferably in the presence of the solvent (S), and then

(ii) where appropriate, of introducing, into the mixture obtained from step (i), the organosilicon compound (E), and then

(iii) introducing into the mixture obtained in step (i) or (ii) the tertiary amine (C).

Preferably, steps (i), (ii) and (iii) are performed at room temperature (about 23° C.) and at atmospheric pressure (about 1 bar).

When the catalytic composition (B) comprises the organosilicon compound (E), step (ii) is then necessary and, preferably, is performed in the order indicated above, permutation of the steps (ii) and (iii) being, however, also possible.

### Other Additives (F)

The adhesive composition according to the invention may comprise other additives (F).

The term “other additives” means additives which are neither silylated polymers (A) nor compounds included in the catalytic composition (B) as defined above.

Among the other additives, mention may be made of fillers, rheological agents, plasticizers, moisture absorbers, UV stabilizers and adhesion promoters.

The adhesive composition according to the invention may comprise fillers, said fillers possibly being inorganic fillers, organic fillers or a mixture of inorganic and organic fillers.

The inorganic fillers may be chosen from calcium carbonates, calcium polycarbonates, aluminum hydroxide, talcs, kaolins, carbon black, silicas and fumed silica, quartz or glass beads.

The organic fillers may be chosen from polyvinyl chloride, polyethylene, polyamide, styrene/butadiene resins or any other organic polymer in powder form.

Preferably, the fillers have a particle size ranging from 0.010 to 20 μm, preferably ranging from 0.020 to 15 μm, more preferably ranging from 0.030 to 5 μm.

The fillers present in the adhesive composition can provide various functions within the composition, for example a rheological agent function.

The fillers may represent up to 80% by weight, preferably from 20% to 70% by weight, more preferably from 30% to 60% by weight, of the total weight of the adhesive composition.

Additives may be provided to adjust the rheology of the adhesive composition according to the application constraints. For example, an additive which increases the yield point (rheological agent) may be added in order to prevent running during the application of the composition, in particular when the surface receiving the layer of adhesive composition is not horizontal.

The rheological agent(s) may represent from 0.01% to 8% by weight, preferably from 0.05% to 6% by weight and more preferably from 0.1% to 5% by weight, relative to the total weight of the adhesive composition.

The plasticizer included as additive (F) in the adhesive composition according to the invention may be chosen from the same list as that given above for the plasticizer which is included in the definition of the solvent (S) optionally included in the catalytic composition (B). The plasticizer included as additive (F) may be identical to (or different from) said plasticizer included in (B).

The plasticizer must be compatible with the polymer and must not demix in the adhesive composition. The plasticizer makes it possible to increase the plasticity (elongation) of the composition and to reduce its viscosity.

When a plasticizer is present in the composition, its content is preferably less than or equal to 20% by weight, preferably less than or equal to 5% by weight, expressed relative to the total weight of the adhesive composition. When it is present, the plasticizer represents from 0.1% to 20% by weight, preferably from 0.5% to 10% and even more preferentially from 0.5% to 5% by weight, relative to the total weight of the adhesive composition.

The moisture absorber, if it is present, may be chosen from vinyltrimethoxysilane (VTMO) such as Silquest® A171 available from the company Momentive, vinyltriethoxysilane (VTEO) such as Geniosil® GF 56 available from the company Wacker or alkoxyarylsilanes such as Geniosil® XL 70 available from the company Wacker.

The moisture absorber makes it possible, in addition to neutralizing the water that may be present in the adhesive composition, for example via the additives, to slightly increase the rate of crosslinking of the adhesive composition when it is too rapid for the intended applications.

When a moisture absorber is present in the composition, its content is preferably less than or equal to 4% by weight, more preferably less than or equal to 3% by weight, expressed relative to the total weight of the adhesive composition. When it is present, the moisture absorber is present in a proportion of from 0.5% to 5% by weight and preferably 1% to 3% by weight relative to the total weight of the adhesive composition. If it is present in excessive amount, the moisture absorber may cause an increase in the crosslinking time of the adhesive composition.

UV and heat stabilizers may be added in order to prevent (slow down or stop) degradation of the polymer, for better resistance to UV radiation or to thermal shocks. Examples that will be mentioned include Tinuvin@ 123, Tinuvin® 326 or Irganox® 245 available from the company BASF.

An example of an adhesion promoter that may be mentioned is aminosilanes. In particular, aminosilanes make it possible to improve the crosslinking of silylated polymers of formula (II) or (II′) or (IV) or (IV′).

### Adhesive Composition

According to a preferred variant of the invention, the adhesive composition comprises, as silylated polymers, silylated polymers of formula (III) or (III′), as described above, and a catalytic composition (B) which comprises an organometallic compound (D) obtained by reaction with cyclohexanone oxime of an alkoxide chosen from: Ti(OnBu)₄, Zn[O(C═O)C₉H₁₉]₂, Bi[O(C═O)C₉H₁₉]₂, Rb[O(C═O)C₉H₁₉] and Cs[O(C═O)C₉H₁₉].

According to a particular embodiment of the invention, the adhesive composition comprises:
from 5% to 90% by weight, preferably from 10% to 70% by weight, more preferably from 15% to 60% by weight, of at least one silylated polymer (A),
from 0.05% to 10% by weight, preferably from 0.1% to 10% by weight, more preferably from 0.1% to 5% by weight, of the catalytic composition (B),

relative to the total weight of the adhesive composition.

According to a particular embodiment of the invention, the adhesive composition comprises, and in particular consists of:
from 5% to 90% by weight, preferably from 10% to 70% by weight, more preferably from 15% to 60% by weight, of at least one silylated polymer (A),
from 0.05% to 10% by weight, preferably from 0.1% to 10% by weight, more preferably from 0.1% to 5% by weight, of the catalytic composition (B),
from 10% to 80% by weight, preferably from 20% to 70% by weight, more preferably from 30% to 60% by weight, of at least one filler,

relative to the total weight of the adhesive composition.

According to a particular embodiment of the invention, the adhesive composition comprises, and in particular consists of:
from 5% to 90% by weight, preferably from 10% to 80% by weight, more preferably from 15% to 70% by weight, of at least one silylated polymer (A),
from 0.05% to 10% by weight, preferably from 0.1% to 10% by weight, more preferably from 0.1% to 5% by weight, of the catalytic composition (B),
from 10% to 80% by weight, preferably from 20% to 70% by weight, more preferably from 30% to 60% by weight, of at least one filler,
from 0.05% to 20%, preferably from 0.1% to 15%, more preferably from 0.5% to 10% by weight of at least one other additive chosen from adhesion promoters, plasticizers, moisture absorbers, rheological agents and UV and heat stabilizers,

relative to the total weight of the adhesive composition.

Preferably, the adhesive composition according to the invention has a viscosity ranging from 10 to 100 Pa·s, measured at 23° C. using a standard rheometer, taking a Bingham model.

The adhesive composition according to the invention is preferably conditioned and stored in a moisture-proof leaktight cartridge.

According to one embodiment, the adhesive composition according to the invention is in a two-component form in which the silylated polymer (A) and the catalytic composition (B) are packaged in two separate compartments.

The adhesive composition is not crosslinked before it is used, for example by application to a support. The adhesive composition according to the invention is applied under conditions which enable it to be crosslinked. The crosslinking of the adhesive composition has the effect of creating, between the polymer chains of the silylated polymer described above and under the action of atmospheric moisture, bonds of siloxane type which result in the formation of a three-dimensional polymer network.

The adhesive composition according to the invention may be prepared by mixing the silylated polymer(s) (A) and the catalytic composition (B) at a temperature ranging from 10° C. to 40° C. and at a relative humidity ranging from 20% to 55% (±5%). When fillers are present in the adhesive composition, the catalytic composition (B) is preferably added in a second step, after mixing the silylated polymer(s) and the fillers. The other optional additives are introduced in accordance with the normal usages.

The adhesive composition according to the invention may be packaged in a kit comprising at least two separate compartments and comprising the adhesive composition according to the invention.

Said kit may comprise water, it being understood that, in this case, the water and the silylated polymer(s) are packaged in two separate compartments.

Thus, in such a kit, the adhesive composition according to the invention may be in a two-component form in which the silylated polymer (A) and the catalytic composition (B) are packaged in two separate compartments. According to this embodiment, the kit may also optionally comprise water in a third compartment.

According to another embodiment, the kit according to the present invention may comprise the adhesive composition in one-component form in one compartment and water in the second compartment. For example, according to this embodiment, the second compartment may comprise an aqueous solution of polyol.

Thus, during the application of the adhesive composition, the constituents of the compartments of the kit according to the invention are mixed so as to enable the crosslinking of the silylated polymer(s).

A subject of the present invention is also a catalytic composition (B) comprising:
a tertiary amine (C) with a pKa of greater than 11; and
an organometallic compound (D) obtained by reacting at least one metal alkoxide (D1) with at least one oxime (D2) chosen from an oxime of formula (V) or an oxime of formula (VI):

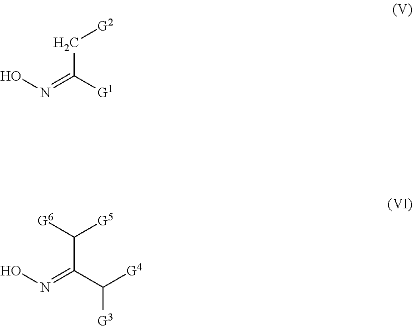

in which:
G¹ is a hydrogen atom or a linear or branched alkyl radical comprising from 1 to 4 carbon atoms;
G² is a hydrogen atom or a radical chosen from a linear or branched alkyl radical comprising from 1 to 10 carbon atoms, a linear or branched alkenyl radical comprising from 2 to 10 carbon atoms, a cyclic alkyl radical comprising from 3 to 10 carbon atoms, an aryl radical or a radical —N(G⁷G⁸) in which G⁷ and G⁸ represent, independently of each other, a linear or branched alkyl radical comprising from 1 to 10 carbon atoms or a linear or branched alkenyl radical comprising from 2 to 10 carbon atoms or a benzyl radical;
G³ represents either a hydrogen atom, or an alkyl group containing from 1 to 4 carbon atoms, or forms the residue of an aliphatic ring containing between 4 and 14 carbon atoms with the groups G⁴ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
G⁴ represents either a hydrogen atom, or an alkyl group containing from 1 to 4 carbon atoms, or forms the residue of an aliphatic ring containing between 4 and 14 carbon atoms with the groups G³ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G³ or G⁴ forms the residue of an aliphatic ring with at least one of the groups G⁵ or G⁶.
G⁵ represents either a hydrogen atom, or an alkyl group containing from 1 to 4 carbon atoms, or forms the residue of an aliphatic ring containing between 4 and 14 carbon atoms with the groups G³ and/or G⁴ and/or G⁶, said aliphatic ring optionally comprising one or more heteroatoms and/or one or more double bonds and said aliphatic ring being optionally substituted with one or more alkyl groups containing from 1 to 4 carbon atoms;
G⁶ represents either a hydrogen atom, or an alkyl group containing from 1 to 4 carbon atoms, or forms the residue of an aliphatic ring containing between 4 and 14 carbon atoms with the groups G³ and/or G⁴ and/or G⁵, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G⁵ or G⁶ forms the residue of an aliphatic ring with at least one of the groups G³ or G⁴.

The catalytic composition (B) that is the subject of the invention is as defined above in the description of the adhesive composition that is the subject of the invention, and also presents the various embodiments that have been detailed in said description.

The present invention also relates to a bonding process comprising the application of the adhesive composition according to the invention to a surface, followed by the crosslinking of said adhesive composition.

The crosslinking of the adhesive composition is promoted by moisture, in particular by atmospheric moisture.

The adhesive composition according to the invention may be applied to any type of surface, such as concrete, tiles, metal, glass, wood and plastic.

The invention is now described in the following implementation examples, which are given purely by way of illustration and should not be interpreted in order to limit the scope thereof.

### EXAMPLE CD 1

Catalytic Composition (B):

17.6 mmol of cyclohexanone oxime were dissolved in 16 mmol of Mesamoll® in a 30 ml glass reactor, stirring for 1 hour 30 minutes at room temperature under vacuum.

Next, 17.6 mmol of Ti(OnBu)₄ were added to the preceding solution under nitrogen, and the mixture was stirred for 3 hours at room temperature under vacuum to give a pale yellow solution composed of titanium/oxime complexes.

Finally, 35.2 mmol of DBU were introduced into this solution. The mixture was stirred for 1 hour to obtain a catalytic composition cdl in the form of an orange solution composed of titanium/oxime complexes in equilibrium with the DBU.

Adhesive Composition:

The catalytic composition CD 1 thus obtained was incorporated into an adhesive composition prepared by simple mixing, in a rapid mixer, of the following ingredients:
41.8% by weight of MS polymer (MS S303H from Kaneka),
53% by weight of fillers of precipitated calcium carbonate type,
2.8% by weight of a moisture absorber of vinyltrimethoxysilane (VTMO) type,
1.4% by weight of an adhesion promoter of aminopropyltrimethoxysilane type and
1% by weight of the catalytic composition CD 1.

The adhesive composition thus prepared was subjected to the following tests:

Test for Measuring the Crosslinking Time

The crosslinking time (also known as the “skinning time”) was evaluated by touching the surface of the adhesive composition with a pointed implement every 5 minutes for 2 hours and then every 30 minutes up to 4 hours (ambient conditions: 50% relative humidity and temperature of 23° C.). The composition was considered to be non-crosslinked as long as, during touching of the surface, adhesive residues were transferred onto the pointed implement.

The result (expressed in minutes) is indicated in Table 1 below.

Stability Test

A portion of the adhesive composition prepared above is conditioned in a cartridge which is stored in an oven at 40° C.

After 21 days, the cartridge is removed from the oven and part of the composition is poured into an aluminum crucible, for the purpose of measuring the crosslinking time (in minutes) according to the above protocol.

The results are indicated in the following manner:

A “2” indicates that the adhesive composition is very stable (crosslinking time after storage for 21 days identical to the crosslinking time measured just after preparation of the adhesive composition),

A “1” indicates that the adhesive composition is stable (crosslinking time after storage for 21 days different but close to the crosslinking time measured just after preparation of the adhesive composition),

A “0” indicates that the adhesive composition is not stable (crosslinking time after storage for 21 days very different from the crosslinking time measured just after preparation of the adhesive composition),

The result (expressed in minutes) is indicated in Table 1 below.

### Examples CD 2-CD 13 and Example a (Comparative)

Example CD 1 is repeated in detailed manner hereinbelow for each of these examples.

The crosslinking time results for the corresponding adhesive composition and the stability test results are indicated in Table 1 below.

### EXAMPLE CD 2

Example CD 1 is repeated, replacing the DBU with the catalyst of phosphazene type P1.

### EXAMPLE CD 3

Example CD 1 is repeated, replacing the DBU with the catalyst of phosphazene type BEMP.

### EXAMPLE CD 4

Example CD 1 is repeated, replacing the DBU with TBD.

### EXAMPLE CD 5

Example CD 1 is repeated, replacing the 16 mmol of Mesamoll® with 47 mmol of xylene.

### EXAMPLE CD 6

Example CD 1 is repeated, replacing the 16 mmol of Mesamoll® with 10.6 mmol of pentaerythrityl tetravalerate.

### EXAMPLE CD 7

Example CD 1 is repeated, replacing the 16 mmol of Mesamoll® with 56.7 mmol of ethyl acetate.

### EXAMPLE CD 8

Example CD 1 is repeated, replacing Ti(OnBu)₄ with Zn[O(C═O)C₉H₁₉]₂.

### EXAMPLE CD 9

Example CD 1 is repeated, replacing Ti(OnBu)₄ with Bi[O(C═O)C₉H₁₉]₂.

### EXAMPLE CD 10

Example CD 1 is repeated, replacing Ti(OnBu)₄ with Rb[O(C═O)C₉H₁₉].

### EXAMPLE CD 11

Example CD 1 is repeated, replacing Ti(OnBu)₄ with Cs[O(C═O)C₉H₁₉].

### EXAMPLE CD 12

Example CD 1 is repeated, replacing the 17.6 mmol of Ti(OnBu)₄ with 2.9 mmol of this same compound, and replacing the 35.2 mmol of DBU with 68.3 mmol.

### EXAMPLE CD 13

Example CD 1 is repeated, replacing the 17.6 mmol of Ti(OnBu)₄ with 8.8 mmol of this same compound, and replacing the 35.2 mmol of DBU with 55.2 mmol.

### EXAMPLE A (COMPARATIVE)

Example CD 1 is repeated, without introduction of DBU.

Example B (reference): adhesive composition with a tin catalyst The adhesive composition of Example CD1 is reproduced, replacing the 1% of catalytic composition CD1 with 0.6% of dioctyltin and adjusting the percentages of the other ingredients.

### EXAMPLE C (REFERENCE): ADHESIVE COMPOSITION WITH A ZINC-BASED CATALYST

The adhesive composition of Example CD1 is reproduced, replacing the 1% of catalytic composition CD1 with 1% of zinc neodecanoate.

The crosslinking time results and the stability test results are indicated in Table 1 below.

### EXAMPLE CDE 1

Catalytic Composition (B):

A catalytic composition CDE 1 is prepared by repeating the protocol for preparing the catalytic composition of Example CD 1, except that 7.7 mmol of TEOS oligomer are also introduced into the pale yellow solution composed of titanium/oxime complex and prior to the addition of the 35.2 mmol of DBU, said introduction being immediately followed by stirring of the mixture obtained for 30 minutes.

Adhesive Composition:

The protocol for preparing the adhesive composition of Example CD 1 is repeated, replacing the catalytic composition CD 1 with the catalytic composition CDE 1 thus prepared.

The adhesive composition thus obtained is subjected to the following tests:
measurement of the crosslinking time in accordance with the protocol detailed in Example CD 1,
measurement of the tensile stress according to the protocol described below.

Measurement of the Breaking Stress by Tensile Testing:

The principle of the measurement consists in drawing, in a tensile testing machine, the movable jaw of which is displaced at a constant speed equal to 100 mm/minute, a standard test specimen consisting of the crosslinked adhesive composition, and in recording, at the moment when the test specimen breaks, the applied tensile stress (in MPa).

The standard test specimen is dumbbell-shaped, of H2 type, as illustrated in the international standard ISO 37. The narrow part of the dumbbell used has a length of 20 mm, a width of 4 mm and a thickness of 3 mm.

To prepare the dumbbell, the adhesive composition to be tested is placed in a Teflon mold, and the composition is left to crosslink for 14 days under the standard conditions (23° C. and 50% relative humidity).

The results obtained for the crosslinking time (expressed in minutes) and the breaking stress (expressed in MPa) are indicated in Table 2 below.

### Examples CDE 2 to CDE 11

Catalytic Composition (B):

For each of the examples CDE 2 to CDE 11, a catalytic composition is prepared by repeating Example CDE 1 in which the catalytic composition of Example CD 1 is replaced with, respectively, the catalytic composition of each of the examples CD 2 to CD 11.

Adhesive Composition:

The adhesive compositions corresponding to the catalytic compositions thus prepared are obtained by repeating the protocol of Example CDE 1, by simply replacing the catalytic composition CDE 1 with the appropriate catalytic composition.

The results obtained for the crosslinking time (expressed in minutes) and the breaking stress (expressed in MPa) are indicated in Table 2 below.

The results obtained for the crosslinking time and the breaking stress corresponding to Examples A, B and C (expressed in MPa) are also indicated in Table 2 below.

### EXAMPLE CDE 20

Example CDE 1 is repeated, replacing the TEOS oligomer with Geniosil® GF 69.

The results obtained for the crosslinking time (expressed in minutes) and the breaking stress (expressed in MPa) are indicated in Table 2 below.

### EXAMPLE CDE 21

Example CDE 1 is repeated, replacing the TEOS oligomer with Dynasylan® 1124.

The results obtained for the crosslinking time (expressed in minutes) and the breaking stress (expressed in MPa) are indicated in Table 2 below.

### EXAMPLE CDE 22

Example CDE 1 is repeated, replacing the TEOS oligomer with Dow Corning® 3074.

The results obtained for the crosslinking time (expressed in minutes) and the breaking stress (expressed in MPa) are indicated in Table 2 below.

### EXAMPLE CDE 23

Example CDE 1 is repeated, replacing the TEOS oligomer with SIT8716.3.

The results obtained for the crosslinking time (expressed in minutes) and the breaking stress (expressed in MPa) are indicated in Table 2 below.

TABLE 1
Catalytic compositions consisting essentially of the tertiary
amine (C) and of the organometallic compound (D)

| | Crosslinking | Stability on storage |
|---|---|---|
| | time | in a cartridge (in |
| Catalytic composition (B) | (in mm) | minutes) |
| Example A (comp.) | 80 | 2 |
| Example B (ref.) | 45 | 2 |
| Example C (ref.) | 75 | 2 |
| Example CD 1 | 30 | 2 |
| Example CD 2 | 45 | 0 |
| Example CD 3 | 40 | 0 |
| Example CD 4 | 30 | 1 |
| Example CD 5 | 35 | 2 |
| Example CD 6 | 30 | 2 |
| Example CD 7 | 35 | 2 |
| Example CD 8 | 40 | 2 |
| Example CD 9 | 45 | 2 |
| Example CD 10 | 40 | 2 |
| Example CD 11 | 35 | 2 |
| Example CD 12 | 40 | 2 |
| Example CD 13 | 40 | 2 |

TABLE 2
Catalytic compositions consisting essentially of the
tertiary amine (C), of the organometallic compound (D) and
of the organosilicon compound (E)

| | Crosslinking time | Breaking stress |
|---|---|---|
| Catalytic composition (B) | (in min) | (MPa) |
| Example A (comp.) | 80 | 2.3 |
| Example B (ref.) | 45 | 2.7 |
| Example C (ref.) | 75 | 2.0 |
| Example CDE 1 | 30 | 2.8 |
| Example CDE 2 | 45 | 1.0 |
| Example CDE 3 | 40 | 0.4 |
| Example CDE 4 | 30 | 2.9 |
| Example CDE 5 | 35 | 3.2 |
| Example CDE 6 | 30 | 2.9 |
| Example CDE 7 | 35 | 3.2 |
| Example CDE 8 | 40 | 3.2 |
| Example CDE 9 | 45 | 2.9 |
| Example CDE 10 | 40 | 2.8 |
| Example CDE 11 | 35 | 2.8 |
| Example CDE 20 | 40 | 2.7 |
| Example CDE 21 | 40 | 3.1 |
| Example CDE 22 | 30 | 3.2 |
| Example CDE 23 | 45 | 2.7 |

1. An adhesive composition comprising:
at least one silylated polymer (A) comprising at least one, preferably at least two, groups of formula (I):
—Si(R⁴)ₚ(OR⁵)₃₋ₚ (I)
in which:
R⁴ represents a linear or branched alkyl radical comprising from 1 to 4 carbon atoms, with the possibility that when there are several radicals R⁴, these radicals are identical or different;
R⁵ represents a linear or branched alkyl radical comprising from 1 to 4 carbon atoms, with the possibility that when there are several radicals R⁵, these radicals are identical or different, with the possibility that two groups OR⁵ may be engaged in the same ring;
p is an integer equal to 0, 1 or 2; and
a catalytic composition (B) comprising:
a tertiary amine (C) with a pKa of greater than 11; and
an organometallic compound (D) obtained by reacting at least one metal alkoxide (D1) with at least one oxime (D2) chosen from an oxime of formula (V) or an oxime of formula (VI): 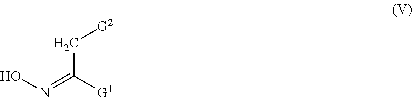 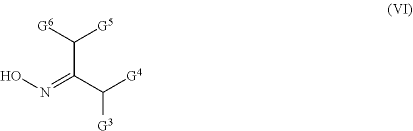
in which:
G¹ is a hydrogen atom or a linear or branched alkyl radical comprising from 1 to 4 carbon atoms;
G² is a hydrogen atom or a radical chosen from a linear or branched alkyl radical comprising from 1 to 10 carbon atoms, a linear or branched alkenylradical comprising from 2 to 10 carbon atoms, a cyclic alkyl radical comprising from 3 to 10 carbon atoms, an aryl radical or a radical —N(G⁷G⁸) in which G⁷ and G⁸ represent, independently of each other, a linear or branched alkyl radical comprising from 1 to 10 carbon atoms or a linear or branched alkenyl radical comprising from 2 to 10 carbon atoms or a benzyl radical;
G³ represents either a hydrogen atom, or an alkyl group containing from 1 to 4 carbon atoms, or forms the residue of an aliphatic ring containing between 4 and 14 carbon atoms with the groups G⁴ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
G⁴ represents either a hydrogen atom, or an alkyl group containing from 1 to 4 carbon atoms, or forms the residue of an aliphatic ring containing between 4 and 14 carbon atoms with the groups G³ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms; it being understood that at least one of the groups G³ or G⁴ forms the residue of an aliphatic ring with at least one of the groups G⁵ or G⁶;
G⁵ represents either a hydrogen atom, or an alkyl group containing from 1 to 4 carbon atoms, or forms the residue of an aliphatic ring containing between 4 and 14 carbon atoms with the groups G³ and/or G⁴ and/or G⁶, said aliphatic ring optionally comprising one or more heteroatoms and/or one or more double bonds and said aliphatic ring being optionally substituted with one or more alkyl groups containing from 1 to 4 carbon atoms;
G⁶ represents either a hydrogen atom, or an alkyl group containing from 1 to 4 carbon atoms, or forms the residue of an aliphatic ring containing between 4 and 14 carbon atoms with the groups G³ and/or G⁴ and/or G⁵, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G⁵ or G⁶ forms the residue of an aliphatic ring with at least one of the groups G³ or G⁴.

2. The adhesive composition as claimed in claim 1, characterized in that the silylated polymer (A) corresponds to one of the formulae (II), (Ill) or (IV): 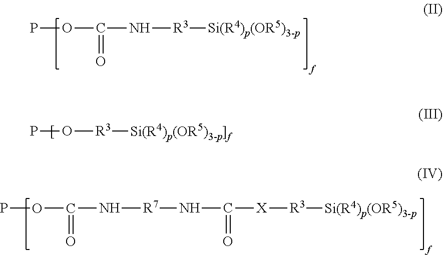
in which:
R⁴, R⁵ and p have the same meaning as in formula (I) described in claim 1,
P represents a saturated or unsaturated, linear or branched polymeric radical optionally comprising one or more heteroatoms, such as oxygen, nitrogen, sulfur or silicon,
R¹ represents a divalent hydrocarbon-based radical comprising from 5 to 15 carbon atoms, which may be aromatic or aliphatic, linear, branched or cyclic,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
f is an integer ranging from 1 to 6.

3. The adhesive composition as claimed in claim 2, characterized in that the silylated polymer (A) corresponds to one of the formulae (II′), (III′) or (IV′): 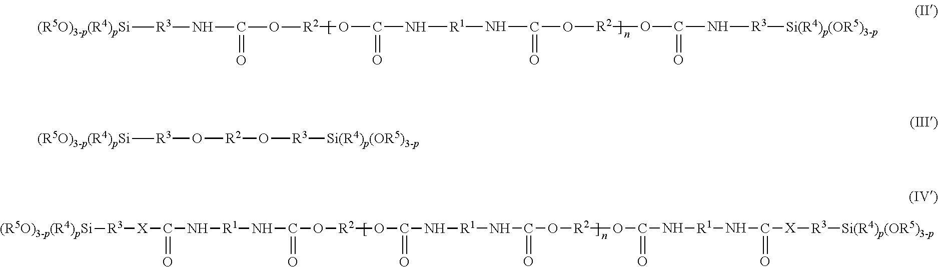
in which:
R¹, R³, R⁴, R, X, R⁷ and p have the same meaning as in formulae (II), (III) and (IV) described in claim 2,
R² represents a saturated or unsaturated, linear or branched divalent hydrocarbon-based radical optionally comprising one or more heteroatoms, such as oxygen, nitrogen, sulfur or silicon,
n is an integer greater than or equal to 0.

4. The adhesive composition as claimed in claim 3, characterized in that the silylated polymer (A) is such that the radical R² included in formulae (II′), (III′) and (IV′) is derived from a polypropylene glycol.

5. The adhesive composition as claimed 1, characterized in that the catalytic composition (B) comprises, as tertiary amine (C), a phosphazene (C1) of formula (VII): 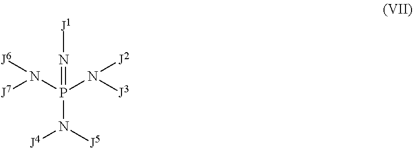
in which:
J¹ represents a linear or branched alkyl radical comprising from 1 to 6 carbon atoms,
J² and J³ represent, independently of each other, an alkyl radical comprising from 1 to 4 carbon atoms or together form, with the nitrogen atom to which they are attached, an aliphatic heterocycle comprising from 4 to 6 carbon atoms;
J⁴ and J⁵ represent, independently of each other, an alkyl radical comprising from 1 to 4 carbon atoms or together form, with the nitrogen atom to which they are attached, an aliphatic heterocycle comprising from 3 to 4 carbon atoms;
J⁶ and J⁷ represent, independently of each other, an alkyl radical comprising from 1 to 4 carbon atoms or together form, with the nitrogen atom to which they are attached, an aliphatic heterocycle comprising from 4 to 6 carbon atoms;
it also being understood that J⁴ (or J⁵) may form with at least one of the groups J⁶ (or J⁷) and/or J² (or J), and also with the two nitrogen atoms and the phosphorus atom to which they are attached, an aliphatic ring comprising 3 to 4 carbon atoms.

6. The adhesive composition as claimed 1, characterized in that the catalytic composition (B) comprises, as tertiary amine (C), a guanidine or an amidine with a pKa of greater than 11.

7. The adhesive composition as claimed in claim 1, characterized in that the catalytic composition (B) comprises an organometallic compound (D) which is obtained by reaction of a metal alkoxide (D1) in the form of formula (VIII):
M(OR)_{y} (VIII)
in which:
M represents a metal atom, preferably chosen from titanium, zirconium, aluminum, zinc, bismuth, silicon, hafnium, barium, cerium, cesium, rubidium and antimony,
y is equal to 1, 2, 3 or 4 according to the valency of the metal atom M, and
R represents an alkyl, alkenyl, carbonyl-alkyl or carbonyl-alkenyl group, said alkyl or alkenyl radical comprising from 1 to 22 carbon atoms, preferably from 1 to 15 carbon atoms.

8. The adhesive composition as claimed in claim 1, characterized in that the catalytic composition (B) comprises an organometallic compound (D) which is obtained by reacting the metal alkoxide (D1) with an oxime (D2) of formula (VI) in which:
G³ and G⁶ each represent a hydrogen atom, and/or
G⁴ and G⁵ form an aliphatic ring containing from 4 to 14 carbon atoms.

9. The adhesive composition as claimed in claim 1, characterized in that the catalytic composition (B) comprises an organometallic compound (D) which is obtained by reacting the metal alkoxide (D1) with the oxime (D2) in an alkoxide/oxime mole ratio ranging from 1:1 to 1:6.

10. The adhesive composition as claimed in claim 1, characterized in that the catalytic composition (B) comprises the tertiary amine (C) and the organometallic compound (D) in a respective amount corresponding to a ratio: number of moles of (C)/number of moles of the metal alkoxide (D1) within the range from 0.5 to 25.

11. The adhesive composition as claimed in claim 1, characterized in that the catalytic composition (B) comprises, besides the tertiary amine (C) and the organometallic compound (D), an organosilicon compound (E) chosen from:
a silsesquioxane (E1);
a compound (E2) of formula (IX):
K[—Si(OR⁶)₃]ᵥ (IX)
in which:
K is a saturated or unsaturated, linear or branched hydrocarbon-based radical comprising from 2 to 15 carbon atoms and one or more heteroatoms chosen from nitrogen and oxygen;
R⁶ represents a linear or branched alkyl or alkenyl group, preferably alkyl, containing from 1 to 5 carbon atoms, preferably from 1 to 2 carbon atoms;
v equal to 1, 2 or 3; and
a tetraethyl orthosilicate oligomer (E3).

12. The adhesive composition as claimed in claim 1, characterized in that the catalytic composition (B) represents from 0.05% by weight to 10% by weight relative to the total weight of the adhesive composition.

13. A catalytic composition (B) comprising:
a tertiary amine (C) with a pKa of greater than 11; and
an organometallic compound (D) obtained by reacting at least one metal alkoxide (D1) with at least one oxime (D2) chosen from an oxime of formula (V) or an oxime of formula (VI): 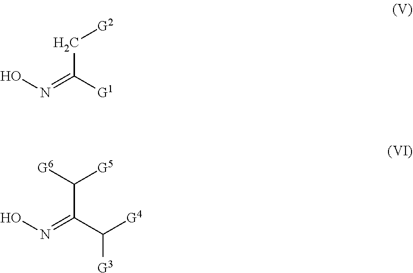
in which:
G¹ is a hydrogen atom or a linear or branched alkyl radical comprising from 1 to 4 carbon atoms;
G² is a hydrogen atom or a radical chosen from a linear or branched alkyl radical comprising from 1 to 10 carbon atoms, a linear or branched alkenylradical comprising from 2 to 10 carbon atoms, a cyclic alkyl radical comprising from 3 to 10 carbon atoms, an aryl radical or a radical —N(G⁷G⁸) in which G⁷ and G⁸ represent, independently of each other, a linear or branched alkyl radical comprising from 1 to 10 carbon atoms or a linear or branched alkenyl radical comprising from 2 to 10 carbon atoms or a benzyl radical;
G³ represents either a hydrogen atom, or an alkyl group containing from 1 to 4 carbon atoms, or forms the residue of an aliphatic ring containing between 4 and 14 carbon atoms with the groups G⁴ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
G⁴ represents either a hydrogen atom, or an alkyl group containing from 1 to 4 carbon atoms, or forms the residue of an aliphatic ring containing between 4 and 14 carbon atoms with the groups G³ and/or G⁵ and/or G⁶, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G³ or G⁴ forms the residue of an aliphatic ring with at least one of the groups G⁵ or G⁶;
G⁵ represents either a hydrogen atom, or an alkyl group containing from 1 to 4 carbon atoms, or forms the residue of an aliphatic ring containing between 4 and 14 carbon atoms with the groups G³ and/or G⁴ and/or G⁶, said aliphatic ring optionally comprising one or more heteroatoms and/or one or more double bonds and said aliphatic ring being optionally substituted with one or more alkyl groups containing from 1 to 4 carbon atoms;
G⁶ represents either a hydrogen atom, or an alkyl group containing from 1 to 4 carbon atoms, or forms the residue of an aliphatic ring containing between 4 and 14 carbon atoms with the groups G³ and/or G⁴ and/or G⁵, said aliphatic ring optionally comprising one or more heteroatoms and/or one or more double bonds and said aliphatic ring being optionally substituted with one or more alkyl groups containing from 1 to 4 carbon atoms;
it being understood that at least one of the groups G⁵ or G⁶ forms the residue of an aliphatic ring with at least one of the groups G³ or G⁴.

14. The catalytic composition (B) as claimed in claim 13, characterized in that the tertiary amine (C), the metal alkoxide (D1), the oxime (D2) and/or the organometallic compound (D) are as defined in one of claims 5 to 10 and/or characterized in that it also comprises the organosilicon compound (E) chosen from;
a silsesquioxane (E1);
a compound (E2) of formula (IX):
K[—Si(OR⁶)₃]ᵥ (IX)
in which;
K is a saturated or unsaturated, linear or branched hydrocarbon-based radical comprising from 2 to 15 carbon atoms and one or more heteroatoms chosen from nitrogen and oxygen;
R⁶ represents a linear or branched alkyl or alkenyl group, preferably alkyl, containing from 1 to 5 carbon atoms, preferably from 1 to 2 carbon atoms;
v equal to 1, 2 or 3; and
a tetraethyl orthosilicate oligomer (E3).

15. A bonding process comprising the application of the adhesive composition as defined in claim 1 to a surface, followed by the crosslinking of said adhesive composition.
